(19) United States
(12) Patent Application Publication
(10) Pub. No.: US 2014/0159281 A1
(43) Pub. Date: Jun. 12, 2014

(54) FORMATION PRESS FOR THREE-DIMENSIONAL PREFORM MANUFACTURE

(71) Applicant: TEMBEC, MONTREAL (CA)

(72) Inventor: MICHAEL A.N. SCOBIE, TEMISCAMING (CA)

(73) Assignee: TEMBEC, MONTREAL (CA)

(21) Appl. No.: 13/708,345

(22) Filed: Dec. 7, 2012

(51) Int. Cl. B29C 43/00

(52) U.S. Cl. CPC B29C 43/003
USPC 264/324

(57) ABSTRACT

Described herein is a formation press for manufacturing a three-dimensional fibrous preform. The press includes a compression zone with an amount of an aqueous slurry of fibrous material. At least two orthogonally disposed compression members are for compressing the material in the compression zone. The compression members are in communication with the compression zone for movement relative to it. The compression members are moveable with sufficient inwardly directed force to compress the material so as to form the three-dimensional perform in the compression zone.

### TECHNICAL FIELD

The present relates to formation presses, and more particularly to a formation press useful to manufacture three-dimensional preforms.

### BACKGROUND

The formation of fiberboard, mats and molded articles from wood by-products is now commonplace. Generally speaking, the formation of such products involves the use of presses with rollers or plates, which limit the dimensions of the end products to flat articles such as papers, boards of a limited thickness of 1 inch maximum and the like. A number of examples of such presses are described below.

U.S. Pat. No. 6,068,804 discloses a process for producing expansion joint material containing asphalt-impregnated fiberboard. A de-watered slurry is pressed in an apparatus to form a wet mat of material. The pressing step uses a series of rollers to press the wet mat as it is fed between the rollers. The apparatus appears to be limited to the creation of mats and does not disclose the use of compression pistons along multiple axes.

U.S. Pat. No. 4,798,529 discloses an apparatus for producing briquettes of fibrous crop in which two compression members with opposing compression faces cooperate with each other to produce briquettes with shapes that are defined by the shape of a plunger. The material to be pressed, i.e., the crop, is dry; however the apparatus used to generate the briquettes is unlikely to be useful with an aqueous slurry of fibrous material.

U.S. Pat. No. 6,123,884 discloses a method whereby lignocellulosic board is manufactured. As with the US patent number 6,068,804 described above, the board is produced by compressing a heated mat to a desired thickness using a steam roller, a compression roller and a calibration roller.

U.S. Pat. No. 5,658,511 describes a method of manufacturing molded articles from lignocellulose and/or cellulose fibers using a series of press tools, which operate along a single axis, to create the molded articles.

U.S. Pat. No. 4,850,849 discloses an apparatus for steam pressing mat material such as lignocellulose. This apparatus includes an upper press platen and a lower press platen, which are used to steam press the mat. The platens are moveable between open and closed position to permit mats of predetermined dimension to be produced. The apparatus appears to be limited to the production of mats.

U.S. Pat. No. 4,035,121 describes an elaborate machine used to form lignocellulosic fiber mats. The main mat forming part includes a pair of suction fans, which compact fibrous material then the material is sucked through the throat of an air bridge, whereupon the material is deposited on screen condensers. The machine is able to produce mats of a certain number of square feet per hour and has the capacity to produce large quantities of such fiber mats. As with the designs described above, this machine does not appear to be capable of producing three dimensional forms.

Disadvantageously, the compression aspects of the above designs appear to be limited to rollers or compression plates. There does not appear to be a suggestion, or contemplation, that a slurry, such as an aqueous lignocellulose slurry can be compressed during de-watering and air removal, using compression pistons operating along multiple axes.

Thus, there is a need for an improved formation press that is able to easily manufacture three-dimensional forms of any dimension, quickly and efficiently.

### BRIEF SUMMARY

We have designed a formation press useful in the manufacture of a three-dimensional fibrous perform which may thereafter be impregnated with a thermoset resin to produce a dry, formed final product, such as a rectangular brick, which is minimally flawed. Advantageously, the result of this triaxial compression is the production of a three dimensional form and not flat mats or boards, which previous designs appear to be limited to.

Accordingly, there is provided a formation press for manufacturing a three-dimensional fibrous preform, the press comprising:
a compression zone having therein an amount of an aqueous slurry of fibrous material; and
at least two orthogonally disposed compression members for compressing the fibrous material in the compression zone, the compression members being in communication with the compression zone for movement relative thereto, the compression members being moveable with sufficient inwardly directed force to compress the fibrous material so as to form the three-dimensional fibrous perform in the compression zone.

In one example, the press includes first, second and third orthogonally disposed compression members moveably mounted in the compression zone for movement relative thereto, the first, second and third compression members being moveable with sufficient inwardly directed force to compress the fibrous material. The first, second and third compression members are disposed for axial movement along respective first, second and third orthogonally disposed compression axes.

In one example, the first, second and third compression members are disposed for axial movement along respective x-, y- and z-axes.

In one example, the first, second and third compression members are compression pistons having first, second and third compression plates connected thereto. The press, according to claim 5, in which the compression pistons are hydraulic pistons.

In one example, the compression zone is a chamber, which includes first, second and third compression sidewalls and a compression base, the first and second compression plates being moveable relative to first, second and third compression sidewalls, the third compression plate being moveable relative to the compression base.

In another example, the second compression sidewall includes a door to remove the compressed perform from the chamber.

In one example, the chamber includes water evacuation valves.

In another example the chamber includes air evacuation valves located at an upper end of the chamber.

In another example, the chamber includes wash water valves located at an upper end of the chamber.

In another example, the chamber includes a slurry inlet.

In another example, the chamber is an elongate cuboid

In yet another example, the chamber is connected to a drying oven.

In one example, the fibrous material is lignocellulose.

### BRIEF DESCRIPTION OF THE DRAWINGS

In order that the discovery may be readily understood, embodiments are illustrated by way of example in the accompanying drawings.

FIG. 1 is a perspective view of a formation press;

FIG. 2 is another perspective view of the formation press showing the location of the compression pistons;

FIG. 3 is an alternative perspective view of the formation press;

FIG. 4 is a partially exploded perspective view of the formation press;

FIG. 5 is alternative partially exploded perspective view of the formation press; and

FIG. 6 is a perspective exploded view of a compression chamber of the formation press.

Further details of the device and its advantages will be apparent from the detailed description included below.

### DETAILED DESCRIPTION

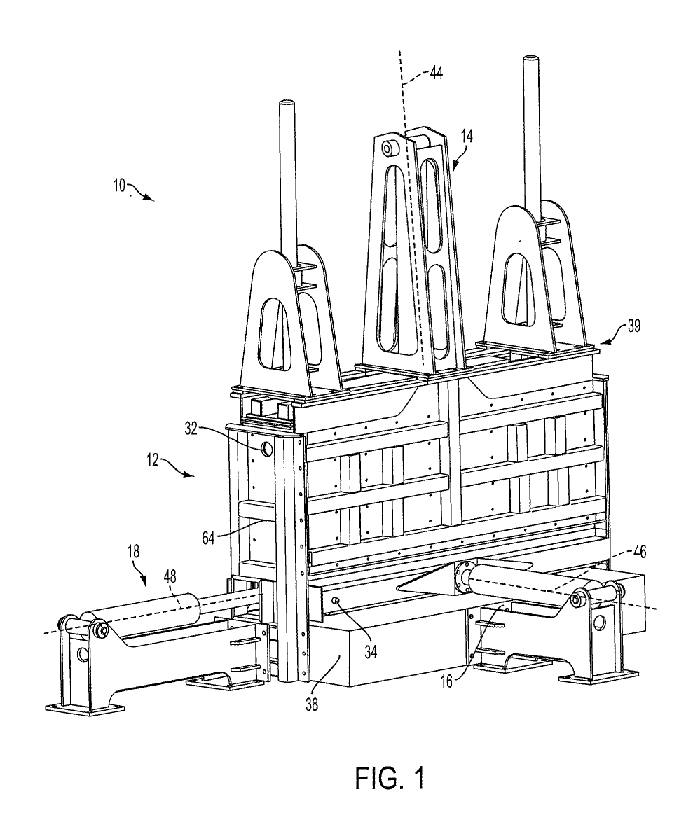

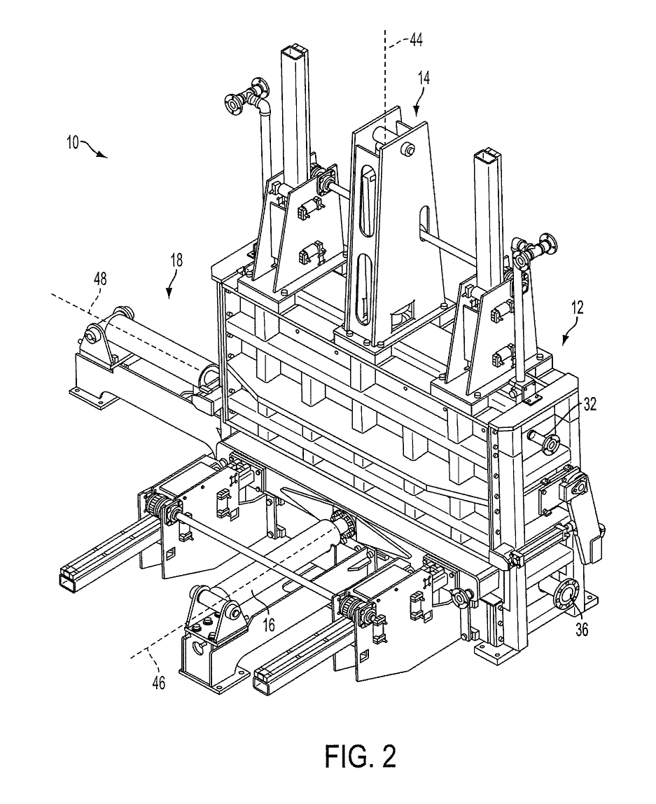

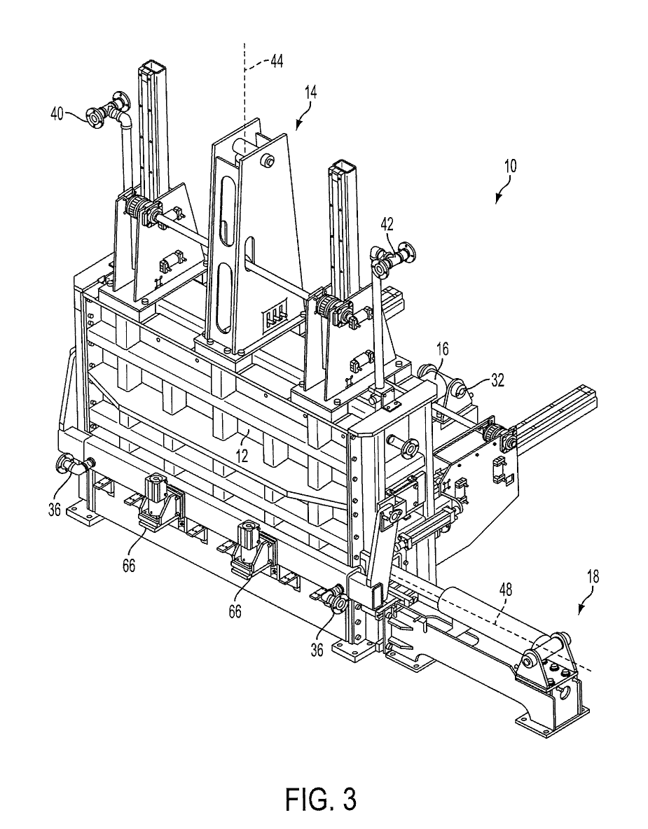

Referring now to FIGS. 1, 2 and 3, a formation press is shown generally at 10. The press 10 is useful for manufacturing a three-dimensional fibrous material perform of unlimited dimension. Preforms, which can be in the form of dried lignocellulose fiber material, which are manufactured using the press 10, are “minimally flawed”. As used herein, the term “minimally flawed” is intended to mean the preform, when either the surface is viewed externally, or a cross section of the preform is viewed, a minimum of at least 90% of the surface or cross section if free of fissures and/or voids. In one example, the minimum is 95%. In one example, lignocellulose fibers can be used in the press 10 and which have an average fiber length of about less than 1.0 cm. In the case of hardwood fibers, the average fiber length is typically about 0.5 to 1.0 mm. In the case of softwood fibers, the average fiber length is typically about 1.0 to 4.0 mm. In the case of non-wood fibers, the average fiber length is typically about 0.5 to 10 mm.

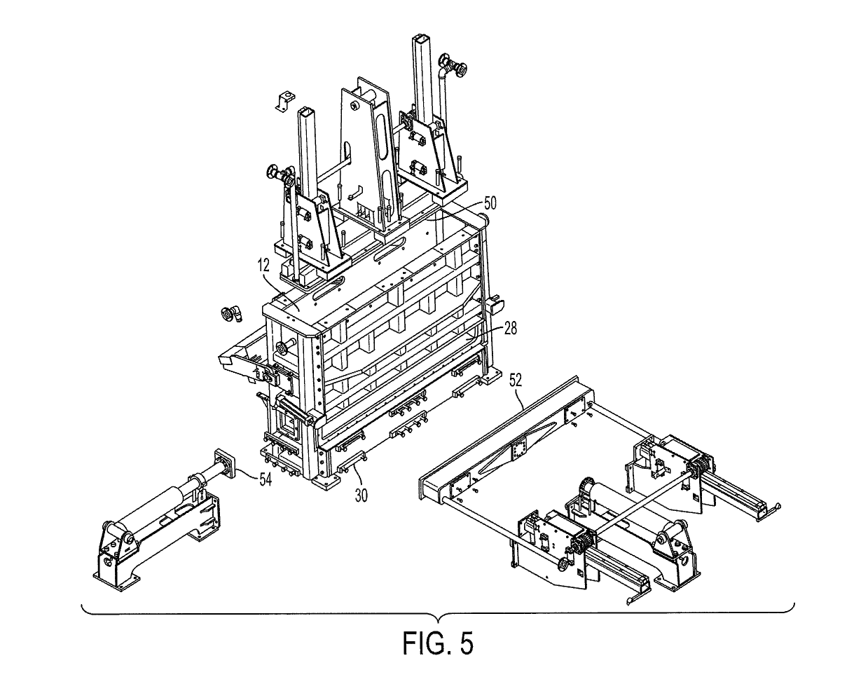

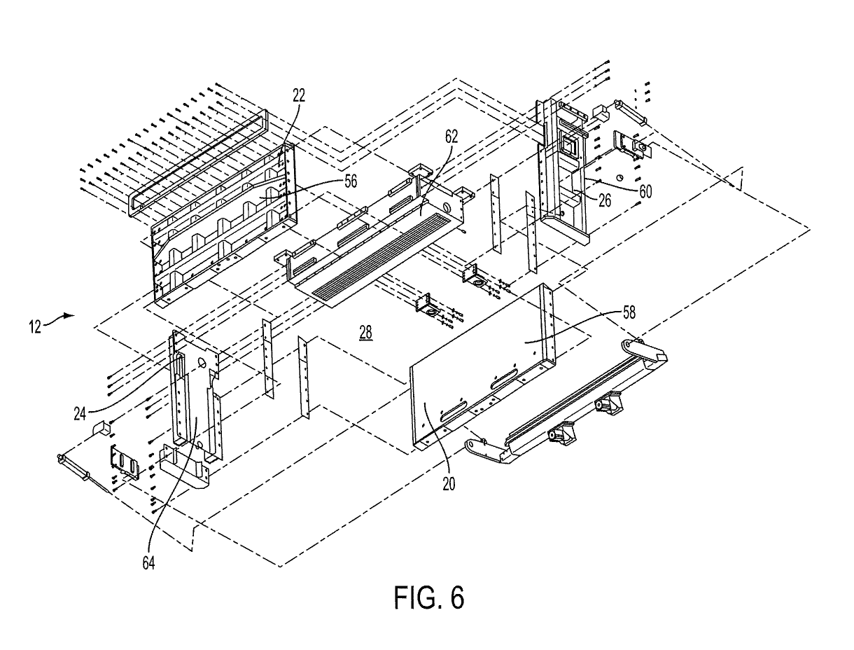

Broadly speaking, the press 10 includes a chamber 12 and first, second and third compression members 14, 16, 18. However, technically, the press 10 could have two compression members in each dimension, totaling six compression members. Typically, the compression members are compression pistons. In one example, the compression pistons are hydraulic pistons. As best illustrated in FIGS. 5 and 6, the chamber 12 includes four main chamber sidewalls 20, 22, 24, 26, which define a compression zone 28 in the chamber 12. Together, the main chamber sidewalls 20, 22, 24, 26 and the compression zone 28 define an elongate cuboid. One skilled in the art will recognize that the dimensions of the chamber 12 can be varied depending on the size of the three-dimensional lignocellulose perform to be manufactured. In the example illustrated, the three-dimensional lignocellulose perform is a rectangular brick. Advantageously, the design of the press 10 permits formation of a three-dimensional preform of unlimited dimension where conventional presses permitted manufacture of performs of limited size and dimension.

Referring still to FIGS. 1, 2, 3 and 4, the chamber 12 includes two inlet ports 32 through which an agitated lignocellulose slurry is introduced as per the methods described in U.S. Pat. No. 7,628,889 and U.S. Pat. No. 7,396,438, and published US patent application number US2010/0038047. The chamber 12 also includes water outlet conduits 34, 36 that are located at a base 38 of the press 10. The water outlet conduits 34, 36 are connected to water outlet valves. The water outlet conduits 34, 36 are in communication with the chamber 12 and permit evacuation of water from the chamber 12 during a compression cycle, as will be described below. At an upper end 39 of the chamber 12 are air outlet conduits 40, 42, which are connected to air outlet valves. The air outlets 40, 42 permit evacuation of air from the chamber 12 during the compression cycle.

As best illustrated in FIG. 1, the compression members 14, 16, 18 are disposed orthogonally relative to each other along respective first, second and third compression axes 44, 46, 48, i.e., their respective x-, y- and z- axes. Although three compression members 14, 16, 18 are illustrated, it is to be understood that any two of the compression members 14, 16, 18 may be used to compress the slurry. The compression members 14, 16, 18 are in communication with the compression zone 28 for movement relative thereto. The compression members 14, 16, 18 are able to move with sufficient inwardly directed force to compress the aqueous lignocellulose material so as to form the three-dimensional lignocellulose perform in the compression zone 28. Typical inwardly directed compression forces exerted by the the hydraulic cylinders would be a minimum of about 500 psi. It should be noted that this is not the actual pressure exerted on the slurry, which is a function of the compression plate size.

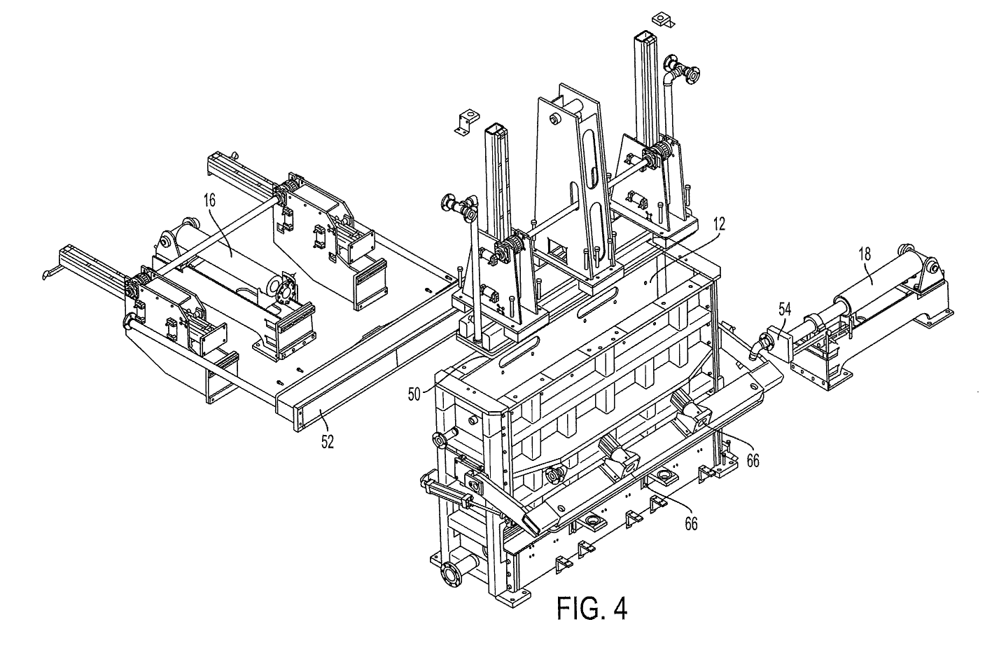

Referring now to FIGS. 4 and 5, each of the compression members 14, 16, 18 includes respectively, first, second and third compression plates 50, 52, 54 connected thereto. The compression plates 50, 52 each have elongate rectangular shaped surfaces, whereas the compression plate 54 has a surface that is generally square and smaller in surface area than the surface area of the compression plates 50, 52. A person skilled in the art will recognize that the size and shape of the compression plates 50, 52, 54 can be changed according to the desired dimensions of the preform.

Referring now to FIG. 6, the chamber 12 includes first, second and third compression sidewalls 56, 58, 60 and a compression base 62. The first and second compression plates 50, 52 are each independently moveable relative to first, second and third compression sidewalls 56, 58 60. The third compression plate 54 is moveable relative to the compression base 62.

As best seen in FIGS. 1 and 6, the chamber 12 also includes a door 64 with a door lock 66 which is located to permit removal of the compressed lignocellulose perform from the compression zone 28 for further processing. Additional pieces of processing machinery, such as a drying oven, are known to those skilled in the art, may be connected to the press 10.

### Operation

Referring now to FIG. 1, a compression cycle will now be described. A predetermined amount of the aqueous lignocellulose slurry is pumped into the chamber 12 via the inlet 32. The predetermined amount of the slurry is predetermined based on the dimensions of the desired end product.

In the case of a biaxial compression along two axes, the compression member 14 begins to move downwardly along its x-axis 44 into the chamber 12 and the water drain valves 34, 36 open so as to release water from the chamber 12. Once the compression member 14 is fully extended, the compression member 16 begins to move along its y-axis 46 to begin y-axial compression. This continues until the desired compressed preform is achieved.

If a triaxial compression is desired, the compression member 18 operating along the z-axis 48 is employed. The compression member 18 is employed, so that the compression member 18 begins compression along the z-axis 48. Once completed, the compression member 18 retracts, the door 64 opens and the compression member 16 pushes the preform out of the press 10.

If z-axial-compression along the z axis 48 is not employed, the y-axial compression along the y-axis 46 goes to desired extension, the door 64 then opens, and the compression member 16 pushes the preform out of press 10.

Although the above description relates to a specific embodiment as presently contemplated by the inventor, it will be understood that the device in its broad aspect includes mechanical and functional equivalents of the elements described herein.

We claim:

1. A formation press for manufacturing a three-dimensional fibrous preform, the press comprising:
a compression zone having therein an amount of an aqueous slurry of fibrous material; and
at least two orthogonally disposed compression members for compressing the fibrous material in the compression zone, the compression members being in communication with the compression zone for movement relative thereto, the compression members being moveable with sufficient inwardly directed force to compress the fibrous material so as to form the three-dimensional fibrous perform in the compression zone.

2. The press, according to claim 1, includes first, second and third orthogonally disposed compression members moveably mounted in the compression zone for movement relative thereto, the first, second and third compression members being moveable with sufficient inwardly directed force to compress the fibrous material.

3. The press, according to claim 2, in which the first, second and third compression members are disposed for axial movement along respective first, second and third orthogonally disposed compression axes.

4. The press, according to claim 3, in which the first, second and third compression members are disposed for axial movement along respective x-, y- and z-axes.

5. The press, according to claim 2, in which the first, second and third compression members are compression pistons having first, second and third compression plates connected thereto.

6. The press, according to claim 5, in which the compression pistons are hydraulic pistons.

7. The press, according to claim 5, in which the compression zone is a chamber, which includes first, second and third compression sidewalls and a compression base, the first and second compression plates being moveable relative to first, second and third compression sidewalls, the third compression plate being moveable relative to the compression base.

8. The press, according to claim 7, in which the second compression sidewall includes a door to remove the compressed perform from the chamber.

9. The press, according to claim 7, in which the chamber includes water evacuation valves.

10. The press, according to claim 7, in which the chamber includes air evacuation valves located at an upper end of the chamber.

11. The press, according to claim 7, in which the chamber includes wash water valves located at an upper end of the chamber.

12. The press, according to claim 7, in which the chamber includes a slurry inlet.

13. The press, according to claim 7, in which the chamber is an elongate cuboid.

14. The press, according to claim 7, in which the chamber is connected to a drying oven.

15. The press, according to claim 1, in which the fibrous material is lignocellulose.
